(19) United States
(12) Patent Application Publication
(10) Pub. No.: US 2004/0210519 A1
(43) Pub. Date: Oct. 21, 2004

(54) System and method for authorizing transactions

(76) Inventors: Carole Oppenlander, Pacifica, CA (US); Trudy Hill, Foster City, CA (US)

Correspondence Address: Pepper Hamilton LLP, One Mellon Center, 50th Floor, 500 Grant Street, Pittsburgh, PA, 15219, US

(21) Appl. No.: 10/844,293

(22) Filed: May 12, 2004

Related U.S. Application Data
(63) Continuation of application No. 10/159,852, filed on May 31, 2002.

(51) Int. Cl. G06K 5/00; G06F 17/60

(52) U.S. Cl. 705/39

(57) ABSTRACT

A system and method for authorizing transactions where a terminal determines if the transaction amount is within a low value limit. If so, a card acts within the parameters of offline counters on the card to generate an offline authorization. The transaction amount is deducted from the available funds balance tracked by an additional counter on the card. Merchants clear the transaction during batch processing in the same manner as other debit or credit transactions. The transactions are treated as standard chip offline-authorized transactions and are sent with other transaction details to an issuer.

### BACKGROUND OF THE INVENTION

The present invention relates generally to the processing of funds transfers. The present invention finds particular application in conjunction with low value transactions and will be described with particular reference thereto. It is to be appreciated, however, that the present invention is also amenable to other like applications where it is desirable to both encourage rapid transactions and limit financial liability deriving from improper use.

Traditionally, low value transactions are cash based. While many transactions have moved to electronic transfers such as credit and debit processing, cash has persisted for most low value payments. Typical explanations for the persistence of cash in these transactions is that cash is perceived as more convenient for consumers than, for example, searching for a designated low value payment card and entering the identification number or signing a receipt. This verification step or Cardholder Verification Method (“CVM”) is required to complete a chip-based debit or credit transaction. Also, cash is commonly considered to be faster at the point of sale for merchants than cards that require online authorization and the inherent administrative details of requiring identification. Still further, credit card payments below a certain threshold, typically between 10-25 U.S. dollars, tend to be unprofitable for merchants due to the online time required to process the transaction and the transaction fee associated therewith. Additionally, in markets where telecommunication costs are high, online authorizations can significantly increase costs.

Attempts have been made in the prior art to solve some of the above-noted problems. For example, stored value and electronic purse products were an early attempt to overcome at least some of these issues. Unfortunately, they have been relatively unsuccessful as stand alone products because of the consumer's resistance to carry additional forms of payment cards in already crowded wallets. Moreover, existing legacy systems for non-cash transactions would not always support stored value and electronic purse products. This resulted in the need for merchants to use an additional terminal at the point of sale and caused retail employee and customer confusion, both of which increased merchant costs. Contributing to these additional costs was the time and effort of maintaining a separate infrastructure and administrative procedures for processing these payments in addition to the other transaction processing, such as credit cards, checks, and cash processing that merchants do daily.

Thus, while others have made attempts at entering the low value, cash dominated transaction market, they have been met with resistance and ultimately, failure.

### SUMMARY OF THE INVENTION

In accordance with one embodiment of the invention, the issuer of a card, to approve low value transactions (“LVT”) offline, personalizes the card so that predetermined data on the card determines whether a transaction will be processed as an LVT or alternatively as a high value transaction. In the event that the terminal supports an LVT, the entire LVT will occur offline.

In accordance with one aspect of the present invention, a method of processing a transaction includes establishing a single transaction limit in a card, such as a so-called smart card or the like. Data is then read from the card including a single transaction limit. The single transaction limit is then compared with a transaction amount, and without user interaction the transaction is approved offline by the card when the transaction amount is less than or equal to the single transaction limit.

In accordance with another aspect of the invention, a method of processing a transaction utilizing an integrated circuit card with a single transaction limit is described. The integrated circuit card receives the transaction amount from the terminal and approves such transactions that are less the single transaction limit and the available funds balance.

In accordance with another aspect of the invention, a smart card specially configured to allow for the processing of low value transactions without the requirement of online authorization, while maintaining a degree of security, is described.

In accordance with another aspect of the present invention, the provision of a low value payment system with short transaction times and little or no additional installation and overhead costs is introduced.

In accordance with another aspect of the present invention, instant offline approval for low value transactions is provided while offering a measured fraud protection commensurate with the level of risk.

In accordance with another aspect of the present invention, little or no physical modification of cards, terminals, and systems is required.

Further advantages and aspects of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 is a simplified graphical representation of a transaction card 10 according to the present invention; and

FIG. 2 is an illustration of a graphical flowchart representing the interaction between a terminal 30 and a transaction card 10, which suitably practices the present invention.

### DETAILED DESCRIPTION OF THE INVENTION

The following terms and acronyms are used throughout the detailed description and are defined as follows:

Authorization — a process where an issuer or a representative of the issuer approves a transaction

Transaction amount—authorized amount of the transaction excluding adjustments

Available funds balance—a card accumulator that is decremented by the transaction amount after an low value offline transaction is approved by the transaction card.

Cardholder—an individual to whom a card is issued or who is authorized to use that card

Card verification method (CVM)—a method used to confirm the identity of a cardholder

Chip/Integrated circuit chip—an electronic component that is designed to perform processing or memory functions

Chip card/Integrated circuit card—a card embedded with a chip that communicates information to a point-of-transaction terminal

Funds limit—the predetermined amount of preapproved funds that is added to the card at the time of personalization; the issuer set limit for available funds that is used by the card to reset the available funds after an online approved transaction; the amount of spending power that the transaction card provides for low value offline transactions

Issuer—a member of a transaction processing entity that issues cards in the name of that transaction processing entity

Issuer authorization code—code on the transaction card that indicates offline approval for low value transactions

Low value transaction—transaction that has a value below a certain threshold limit specified on the terminal (e.g., below $25.00)

Merchant—a business entity that possesses at least one terminal for processing transaction

Offline approval—a transaction that is positively completed at the point-of-transaction between the card and terminal without an authorization request to the issuer

Offline authorization—a method of processing a transaction without sending the transaction online to the issuer for authorization

Offline-capable—a card acceptance device that is able to perform offline approvals

Offline decline—a transaction that is negatively completed at the point-of-transaction between the card and terminal without an authorization request to the issuer

Online approval—a transaction that is positively completed at the point-of-transaction by requesting an authorization through a communications network other than voice to an issuer or issuer representative

Offline transaction limit—a card parameter indicating the maximum number of offline approvals of a low value transaction before online authorization is required

Online authorization—a method of requesting an authorization through a communications network other than voice to an issuer or issuer representative

Personalization—the process of populating the card with the application data that makes it ready for use

Single transaction limit—a card parameter indicating the maximum amount allowed for processing a single low value transaction

Smart card—a commonly used term for a chip card

Terminal—a device capable of reading and/or processing a magnetic stripe or chip on a card for the purpose of performing a service such as obtaining an authorization or processing a payment capability; may include a point-of-transaction or point-of-service device, ATM, or unattended terminal

Terminal transaction limit—a terminal parameter indicating the maximum amount allowed for processing a single low value transaction

Transaction—an exchange of information between a cardholder and a merchant that results in the completion of a financial transaction

Transaction counter—an accumulator that is incremented after offline approval of a low value transaction

Transaction currency code—indicates the currency code of the transaction

Terminal support indicator—a data element, which if present in the terminal, indicates that the terminal supports offline approval of low value transactions

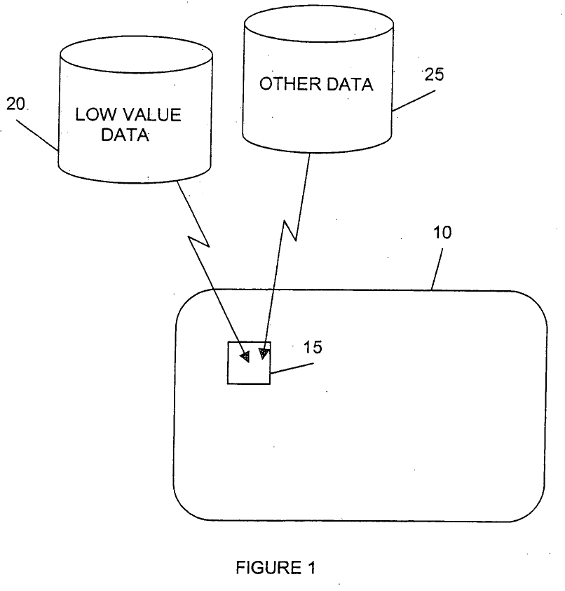

With reference now to FIG. 1, a transaction card 10 includes a computing area or chip 15. The computing area or chip 15 includes typical processor components such as input/output mechanisms, a microprocessor, random-access memory (RAM), read-only memory (ROM), non-volatile memory (e.g. EEPROM), an encryption module and the like. Those skilled in the art will appreciate that the input/output mechanisms can be direct or wired connections, a wireless radio-frequency interface, an optical interface and the like.

Card 10 is capable of receiving and/or storing low value data 20 and other data 25 in a memory device or the like. Low value data 20 is used for special processing of transactions and includes various data elements (e.g., counters) such as an offline transaction counter, a single transaction limit, available funds balance, and a funds limit. Other data 25 includes data elements such as a credit or debit account number, an issuer authorization code, limits, identifiers for the user, the issuing institutions which are accessible with the card, various individual account numbers, and the like. It is important to not that card 10 is capable of handling multiple currencies. To support this, card 10 would include the same amount of counters and limits required to support a single currency. However, the more currencies supported by the card, more risk is involved. Those skilled in the art will realize that initializing and updating low value data 20 and other data 25 stored on card 10 can take place at various points in the lifecycle of card 10. For instance, during the manufacture of card 10, prior to the issuance of card 10, or by way of a post-issuance script. This permits increased personalization of the functionality of the card by, for example, permitting an issuer to increase the permissible number of transactions in a given time period when expected usage levels will be high or to increase the funds limit. Issuers may personalize additional offline spending counters in a card application that is linked to either a debit or a credit account. Once personalized in the card, these additional offline counters separately manage cardholder spending for the different functionalities contained within the card. Similarly, when desirable, the permissible number of transactions may be decreased.

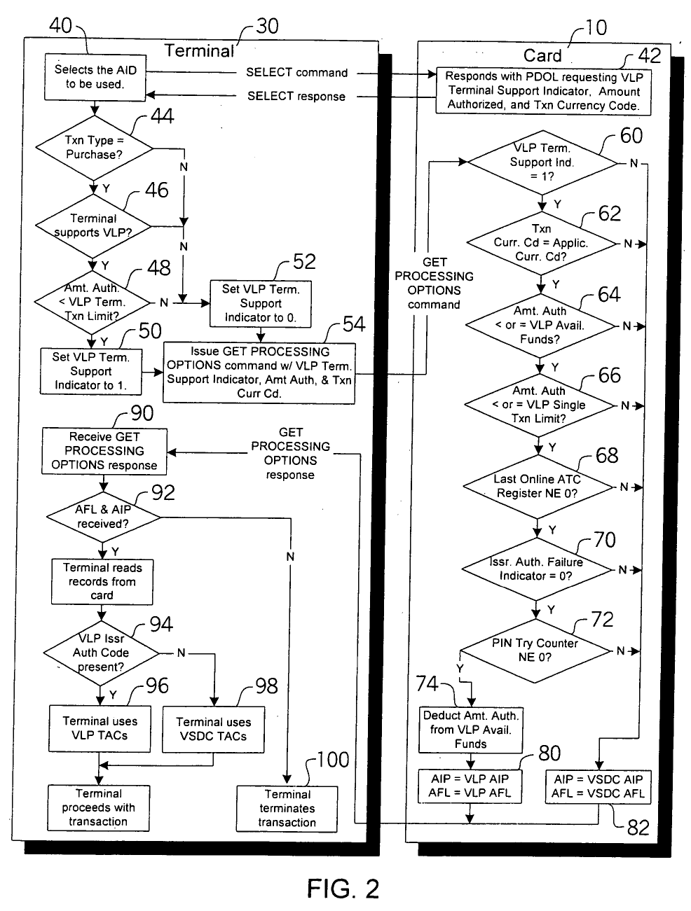

FIG. 2 illustrates the preferred embodiment of offline authorization according to the present invention. Steps in FIG. 2 are indicated with numerals and are not meant to be limiting as to the order of the steps or to require that all steps in the method are necessary to practice the present invention. In its most simplistic form, the present invention requires card 10 and terminal 30. When a consumer desires to purchase an item from a merchant, terminal 30 is prompted to process a transaction having a transaction amount. If the consumer wishes to pay for the item using card 10, card 10 is placed in data communication with terminal 30 to begin the transaction process by selecting an application identifier to be used to process the present transaction.

Terminal 30 then determines whether card 10 is capable of processing a low value transaction (i.e., low value transaction compatible) by transmitting a “Select” command to card 10 as illustrated in step 40. If card 10 is low value transaction compatible, then card 10 requests from terminal 30 data that includes, but is not limited to, a transaction amount, a transaction currency code, and a terminal support indicator as illustrated in step 42. Once terminal 30 receives the data, terminal 30 must satisfy select requirements to support offline approval of a low value transaction. Examples of the requirements include, but are not limited to, verifying that the transaction type is a purchase, step 44; terminal 30 supports approval of low value offline transaction approval, step 46; and that the transaction amount is less than the terminal transaction limit, step 48. Another requirement may be that the offline transaction counter is less than the offline transaction limit. Once the transaction amount is found to be less than the terminal transaction limit, the transaction is considered to be a low value transaction. If all the select requirements are satisfied, the terminal support indicator is set to 1, step 50; if not, the terminal support indicator is set to 0, step 52. Optionally, terminal 30 may prevent a certain percentage of transactions from being performed by automatically set the terminal support indicator to 0 if a transaction is selected. This may be done using a random selection processing. This will ensure online transaction processing for a certain percentage or randomly selected transactions to provide an extra security feature. Terminal 30 parameters may be configurable by the transaction processing entity, merchant, or acquirer.

Terminal 30 transmits the transaction data which includes, but is not limited to, a terminal support indicator, the transaction amount, and the transaction currency code to card 10, step 54. Upon receiving the transaction data, card 10 considers whether the low value transaction should be subject to offline approval if certain parameters are satisfied. Exemplary parameters include verifying that: the terminal support indicator is set to 1 indicating that terminal 30 supports offline approval of low value transactions, step 60; the transaction currency code matches the application currency code, step 62; the transaction amount is less than or equal to the funds balance, step 64; the transaction amount is less than or equal to the single transaction limit (if present on card 10), step 66; the last online ATC register is not equal to zero, step 68; the issuer authentication failure indicator equals zero, step 70; and the PIN try counter does not equal zero, step 72. If these parameters are satisfied, card 10 provides an offline approval of the low value transaction and deducts the transaction amount from the available funds balance, step 74. It is important to note that all of the above-mentioned verification steps (i.e., steps 60-74) are processed internally by card 10 without the involvement of terminal 30.

After the transaction amount is deducted from the available funds balance, data 80 (such as the issuer identification code and the available finds balance) is transmitted to terminal 30 indicating that card 10 has indicated an offline approval of the low value transaction. In the event any of the above described conditions are not satisfied, approval data 82 (such as the issuer identification code and the available funds balance) is transmitted to terminal 30 indicating that the low value transaction has not been offline approved and the low value transaction may be subject to a different offline approval process or an online approval process.

Terminal 30 receives either approval data 80 or data 82 as illustrated in step 90 and verifies that data 80 or data 82 was received, step 92. If data 80 or data 82 was received, terminal 30 reads records from card 10 and checks for an issuer authorization code, step 94. If data 80 or data 82 was not received, then terminal 30 terminates the low value transaction, step 100. If the issuer authorization code is present, appropriate action codes are issued, and the low value transaction is completed with offline authorization, step 96. If the issuer authorization code is not present, appropriate action codes are issued, and the low value transaction is completed with online authorization, step 96.

Once terminal 30 proceeds with the offline authorization of the low value transaction, the offline authorized low value transaction is stored in terminal 30 until the merchant clears the transaction during batch processing conducted in the same manner as standard online transaction processing. In fact, offline authorized low value transactions may be cleared or reconciled in the same way as conventional credit or debit transactions are cleared presently. For example, a merchant may submit the stored offline authorized low value transactions with all other credit and debit transactions during a daily batch submission. Once the low value transaction are reconciled with the issuer, the issuer can either charge the cardholder account if the card is a credit card or debit the cardholder's account if the card is a debit card. Accordingly, in countries where it is difficult to get online (i.e., time consuming) or where online time is expensive, an issuer could still track offline approved low value transactions for a particular cardholder without the cardholder ever undergoing an online approval procedure. Because of the daily batch submission of all types of transactions (including offline approved low value transactions) to respective issuers, an issuer would be able to obtain information about offline approved low value transactions for a particular cardholder and make decisions based on that information. Such decisions may include a request by the issuer to stop future low value transaction purchases by the cardholder, change the funds limit of the card, and change the single transaction limit.

Furthermore, if the cardholder uses the card in a manner that ultimately results in an online approval of a transaction, then any offline approved low value transaction information stored on card 10 may be immediately transmitted online to the issuer for reconciliation purposes. Once these stored offline approved low value transactions are reconciled with the issuer, the issuer can either charge the cardholder account if the card is a credit card or debit the cardholder's account if the card is a debit card.

Those skilled in the art will also appreciate that terminal 30 may optionally record transaction identifying information in a database for daily batch loading to the provider network at a later time, for example, at the close of business, at a location where data communication is available, and the like. Terminal 30 may also provide a receipt upon the consumer's request. Included on the receipt may be items such as the transaction amount, the date and time of the transaction, merchant identifying information, and the remaining available funds balance on card 10.

One way to reset the available funds balance on card 10 (otherwise known as “topping up”) is for the cardholder to use card 10 in such a manner that requires online authorization of a transaction. Once the transaction is successfully authorized online, the available funds balance on card 10 is reset to a predetermined amount by terminal 30. Other ways to reset the available funds balance on card 10 is a status check by the consumer at a point-of-service device or ATM, or after a status check at a dedicated online unattended terminal. Options for “topping up” include: an automatic return of the available funds balance to the funds limit authorized by the issuer and an automatic increase of a predetermined amount determined by issuer. Following a successful online authorization procedure, terminal 30 receives a signal while online to the network to “top off” the available funds balance to the funds limit or the predetermined amount. Terminal 30 in turn transmits this signal to the computing area 12 on card 10 and updates the available funds balance to the funds limit or the predetermined amount. Alternatively, terminal 30 could provide a different signal indicating that the available funds balance should be restored, changed, reduced to zero, or otherwise incremented or decremented. Those skilled in the art will appreciate that terminal 30 may also optionally record details of this particular transaction to a transaction database used for later batch loading to the network for confirmation of the transactions stored thereon.

As an illustrative example, a first transaction amount is $6.83, a second transaction amount is $14.54, and card 10 has an available funds balance of $100.00, a single transaction limit of $25.00, and a funds limit of $150.00. After verifying that both card 10 and terminal 30 are capable of supporting offline low value transaction approvals, card 10 compares the transaction amount to the available funds balance on card 10 indicated in step 64. If the transaction amount is less than the available funds balance on card 10, then card 10 has satisfied at least one condition required for processing a low value offline transaction. In this example, the first transaction amount (i.e., $6.83) is less than the available funds balance (i.e., $100.00) on card 10. Therefore, this condition has been satisfied and the transaction may be approved offline. In the event the transaction amount exceeds the available funds balance, alternate processing can be applied such as a conventional online approval process or a different offline approval process.

According to FIG. 2, the next condition to be satisfied is that the transaction amount is to be less than or equal to the single transaction limit indicated in step 66. If the transaction amount is less than or equal to the single transaction limit, then card 10 has satisfied at least one condition required for processing a low value offline transaction. In this example, the first transaction amount (i.e., $6.83) is less than or equal to the single transaction limit (i.e., $25.00). Therefore, this condition has been satisfied and the transaction may be approved offline. In the event the transaction amount exceeds the single transaction limit, alternate processing can be applied such as a conventional online approval process or a different offline approval process.

It is important to note that the above-mentioned conditions may, by themselves or in combination with other conditions, satisfy the requirements for approving an offline low value payment transaction. Therefore, in a case where two conditions must be satisfied and one condition is satisfied and the other condition is not, the transaction is not offline approvable because the one condition has not been satisfied. Approval of the low value offline transaction by card 10 will allow the consumer to purchase the item without the need for a merchant/consumer to enter additional information or otherwise engage in cardholder verification procedures.

Following offline approval of the low value transaction, the transaction amount is deducted from the available funds balance stored on card 10 and the offline approval is communicated back to terminal 30. In the above example, the available funds balance following the processing of the $6.83 transaction would be $93.17 ($100.00-$6.83). To process the second transaction, card 10 compares the second transaction amount to the available funds balance (now $93.17) and the single transaction limit (i.e., $25.00) on card 10 after verifying that both card 10 and terminal 30 are capable of supporting offline low value transaction approvals. If the two conditions are met and card 10 and terminal 30 are capable of supporting offline low value transaction approvals, then the second transaction may be approved. In the above example, the two conditions have been satisfied because the second transaction amount is less than the available funds balance (now $93.17) and the single transaction limit (i.e., $25.00) on card 10. Thus, the available funds balance following the processing of the $14.54 transaction would be $78.63 ($93.17-$14.54).

As is now evident to skilled artisans, the invention provides replenishable, pre-authorized spending power to be set on a card to handle low value purchases without requiring online authorization. Issuers personalize an approved spending power on a card that can draw from a line of credit or act as an overdraft against a deposit account. A configured terminal recognizes the card, determines if the purchase amount is within the terminal low value limit and the card single transaction limit and, if so, deducts from the card's reserved offline spending power for a fast, offline authorization. The purchase amount is deducted from a balance maintained on the card. Desirably, these transactions then appear on the user's monthly statement permitting tracking of smaller or discretionary amounts. The network handles the transactions as a standard offline, card authorized transaction and sends details to the issuer. The offline spending balance on the card can be replenished when the card receives online approval of a regular transaction, through use of a customer activated terminal, or other mechanism. Issuers can increase transaction volume, add value to typical cards, and offer a new service with minimal infrastructure impact. During online approval transactions, issuers have the opportunity to shut down the low value functionality through the transmission of a special indicator in their response. Consumers could experience lessons in discretionary spending, quick approval, and processing through the point of sale. Merchants receive transaction protection, speedy handling and decreased opportunities for hard currency shrinkage. Merchants can, for those occasions where funds or low balance funds are depleted, revert to a traditional online transaction or request another form of payment.

Protection against fraudulent transaction occurs through at least the following controls: 1) limiting the number of transactions and the amount of funds available to spend offline before the issuer has the opportunity to evaluate if a transaction should be approved online and if the card can continue to be used. 2) validating offline if the card has been tampered with or is counterfeit or skimmed. 3) confirming that the cardholder is the valid user through an offline personal identification number (PIN) or other cardholder verification method. These controls currently provide the same degree of fraud protection, user control, and transaction complexity for small value transaction as they do for high value transactions.

The invention has been described with reference to the preferred embodiments. Modifications and alterations will occur to others upon reading and understanding the preceding specification. It is intended that the invention be construed as including all such alterations and modifications insofar as they come within the scope of the appended claims or the equivalence thereof.

1. A method for conducting an offline transaction, the method comprising:
placing a first device in communication with a point of sale device;
verifying that the transaction satisfies at least one requirement stored on the point of sale device;
transmitting transaction data from the point of sale device to the first device, wherein the transaction data comprises a transaction amount; and
the first device approving the transaction when the transaction amount does not exceed either a single transaction limit or an available funds balance, wherein the single transaction limit is less than the available funds balance.

2. (Cancelled)

3. (Cancelled)

4. (Cancelled)

5. The method of claim 1, further comprising:
decrementing the available funds balance by an amount equal to the transaction amount.

6. The method of claim 1, wherein the first device further comprises an offline transaction counter stored thereon.

7. The method of claim 6, wherein additional processing is required to determine the approval of said transaction if the value of said offline transaction counter is not less than an offline transaction limit stored on the first device.

8. The method of claim 1, wherein the point of sale device prevents a predetermined percentage of transactions from being approved by the first device.

9. The method of claim 1, wherein said at least one requirement is that the value of said transaction is less than a point of sale transaction limit.

10. The method of claim 1, wherein said at least one requirement is that said transaction is a purchase.

11. The method of claim 1, further comprising:
communicating approval data from the first device to the point of sale device following approval of said transaction.

12. The method of claim 11, further comprising:
the point of sale device storing said approval data on a storage device to initiate reconciliation activities.

13. The method of claim 12, further comprising:
the point of sale device transmitting the approval data for batch processing at predetermined time intervals.

14. (Cancelled)

15. (Cancelled)

16. (Cancelled)

17. (Cancelled)

18. (Cancelled)

19. (Cancelled)

20. (Cancelled)

21. (Cancelled)

22. A system for conducting an offline transaction, the system comprising:
a point of sale device which authorizes offline approval of a transaction when a transaction amount is not greater than a point of sale transaction limit; and
a first device having stored thereon a single transaction limit and an available finds balance, wherein said single transaction limit is less an the available funds balance and further wherein the first device is capable of receiving the transaction amount from the point of sale device and approving the transaction, independent of any fiber interaction with the point of sale device, when said transaction amount is not greater than both the single transaction limit and the available funds balance.

23. The system of claim 22, further comprising:
an issuer computer in communication with the first device wherein the issuer computer transmits data to the first device to update the single transaction limit.

24. The system of claim 22, further comprising:
an issuer computer in communication with the first device wherein the issuer computer transmits data to the first device to update the available funds balance.

25. A device for conducting an offline transaction, the device comprising:
first communication means for receiving transaction data from a point of sale device, wherein the transaction data comprises a transaction amount;
memory means for storing a single transaction limit and an available finds balance, wherein the single transaction limit is less than the available funds balance;
processing means for approving the transaction when the transaction amount does not exceed either the single transaction limit or the available finds balance; and
second communication means for transmitting an indication of the approval status of the transaction to the point of sale device.

26. The device of claim 25, further comprising: encryption means for encrypting data transmitted to the point of sale device.

27. The device of claim 25, further comprising: decryption means for decrypting data received by the device.

29. The method of claim 7, wherein the additional processing makes available increased security protocols.
